(19) United States
(12) Patent Application Publication
(10) Pub. No.: US 2004/0044576 A1
(43) Pub. Date: Mar. 4, 2004

(54) Advertisement effect measuring method measuring the effectiveness of an advertisement placed in a printed matter, and a program for causing a computer to execute these methods

(75) Inventors: Shinichirou Kurihara, Isehara (JP); Shouichi Yoshikawa, Kawasaki (JP); Hideyuki Hirano, Kawasaki (JP); Tomohisa Misawa, Kawasaki (JP); Maki Kubota, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/650,979

(22) Filed: Aug. 29, 2003

(30) Foreign Application Priority Data
Aug. 29, 2002 (JP) 2002-251899

(51) Int. Cl. G06F 17/60

(52) U.S. Cl. 705/14

(57) ABSTRACT

Document location information indicating a location of a document on a network is embedded in an image, which is included in an advertisement placed in a printed matter, by using an electronic watermark. The document includes detailed information about the advertisement. The electronic watermark is decoded with terminals TR used by readers R. The terminals TR access an information providing device SC based on the document location information included in the decoded information, and receive the document from the information providing device SC. An access totaling unit within the information providing device SC counts the number of accesses made from the terminals TR, whereby an effect of the advertisement is measured.

### BACKGROUND OF THE INVENTION

1. Field of the Invention

The present invention relates to a technique for enabling an additional service to be provided to a reader of a printed matter such as a newspaper, a magazine, etc., and to an advertiser who places an advertisement in the printed matter.

2. Description of the Related Art

In a printed matter such as a newspaper, a magazine, etc., an advertisement is placed in most cases. To place an advertisement, a requester of an advertisement (hereinafter referred to as an advertiser) must pay an advertisement placement fee to an issuer of a printed matter or an advertisement agency in many cases. An advertisement placement fee is calculated according to a position in which an advertisement is placed in a printed matter, or the size of a space in which the advertisement is placed.

To an advertisement, additional information such as contact information of an advertiser, a coupon for requesting a handout, or the like is sometimes added. In this case, a reader of the printed matter makes an inquiry about detailed information, or makes a request of a handout to an advertiser or an advertisement agency via a telephone, a postcard, etc. based on the additional information.

There are inventions according to which information that cannot be visually recognized by a reader (human being), and must be decoded with a computer, is used as additional information, when the additional information is provided to information printed in a printed matter. According to these inventions, a file location pointer that indicates a location of a document on a network, which has contents associated with a printed matter, is provided to information printed in the printed matter by using a symbol such as a barcode, etc. A computer of a reader who obtains the printed matter is used to read the symbol by using a barcode reader, etc. from the printed matter, obtains a file location by decoding the symbol, and receives the document pointed to by the pointer via a network (for example, see patent documents 1 and 2).

Patent Document 1

Japanese Patent Publication No. 2002-515149

Patent Document 2

Japanese Patent Publication No. 2002-74085 (paragraphs 0035 to 0039 and FIG. 1)

In the case where the effectiveness of an advertisement is measured, an advertiser collects information for measuring the effectiveness of the advertisement by requesting a reader to write the name of the printed matter in which the advertisement is placed, and the position in the printed matter, in which the advertisement is placed, via a postcard, or by verifying the name of a printed matter or a position in the printed matter to the reader via a telephone, when receiving an inquiry or a request of a handout from the reader.

According to conventional techniques including the inventions recited in the above described patent documents, when additional information is provided to information placed in an advertisement or a printed matter, part of a page space in which the information is placed must be spared for the additional information, for example, by reducing the size of a photograph. Accordingly, there is a problem that the entire page space of the printed matter, in which the advertisement is placed, cannot be used effectively due to the advertisement.

Additionally, not many readers clearly remember the name of a printed matter or a position, in which an advertisement is placed. Accordingly, there is a problem that an advertiser cannot accurately measure an effect of the advertisement, because the advertiser cannot properly collect information for measuring the effect of the advertisement.

Furthermore, a reader notifies his or her individual information such as address, name, age, etc. in many cases when making an inquiry or a request of a handout. However, it is difficult for an advertiser or an advertisement agency to manage the individual information by associating with a printed matter in which an advertisement is placed, or the advertisement.

Still further, an advertisement agency or an issuer of a printed matter has no method for measuring the effectiveness of an advertisement placed in a printed matter. Accordingly, there is a problem that an advertisement agency or an issuer of a printed matter cannot set an advertisement placement fee based on the effectiveness of an advertisement.

### SUMMARY OF THE INVENTION

A first object to be achieved by the present invention is to enable the effectiveness of an advertisement to be measured by using additional information while providing the additional information to the advertisement without sparing a page space in which the advertisement is placed, in view of the above described problems. A second object to be achieved by the present invention is to enable an advertisement placement fee to be calculated based on a result of the measurement.

To achieve the above described objects, according to a first preferred embodiment of the present invention, it is configured that image identification information for identifying an image, and document position information indicating a position of a document on a network are embedded by using an electronic watermark in image information which is included in an advertisement placed in a printed matter. The image information in which the electronic watermark is embedded is decoded by a computer when being read by the computer. The image identification information is then transmitted to a different computer that provides a document indicated by the document position information, and the number of accesses from the computers is counted by the different computer. It is desirable that the electronic watermark cannot be visually recognized by a human being, and does not significantly degrade the quality of image information.

Additional information is embedded in image information which is included in an advertisement placed in a printed matter by using an electronic watermark. When detailed information about the advertisement is obtained, the electronic watermark is decoded with a computer, information obtained by the decoding is transmitted to a different computer, and a document indicated by document location information is received. The different computer that provides the document totals the accesses. This enables the effectiveness of the advertisement to be measured by totaling accesses while eliminating the need for sparing a page space in which the advertisement is placed so as to write a contact information, etc. of detailed information about the advertisement. Additionally, a transmission source can easily obtain detailed information about the advertisement in which the transmission source is interested in by using the printed matter.

Additional information that is embedded in image information by using an electronic watermark includes image identification information for identifying an advertisement, printed matter identification information for identifying a printed matter, image position information indicating a position in which an advertisement is placed in a printed matter, and the like in addition to document position information. These information items are added to the image information, whereby the effectiveness of the advertisement can be measured in further detail by using the printed matter.

The present invention utilizes a plurality of devices connected via a network in order to measure the effectiveness of an advertisement placed in a printed matter by using the printed matter. One of these devices is an information obtaining device used by readers of a printed matter, and another is an advertisement effect measuring device measuring an effect of an advertisement.

First of all, the advertisement effect measuring device is described. According to one preferred embodiment of the present invention, the advertisement effect measuring device comprises: a detailed information providing unit receiving decoded information obtained by decoding an electronic watermark embedded in image information which is included in an advertisement printed in a printed matter, and transmitting a document including detailed information about the advertisement to a transmission source of the decoded information based on document location information which is included in the decoded information and indicates a location of a document on a network; and an access totaling unit counting the number of transmission sources of the decoded information.

In the above described configuration, the number of transmission sources that make an access based on the decoded information obtained by decoding the electronic watermark embedded in the image information which is included in the advertisement placed in the printed matter is counted by the access totaling unit, whereby the effectiveness of the advertisement can be measured.

The advertisement effectiveness measuring device may further comprise: a user attribute storing unit storing user attribute information such as individual information of a reader registered as a user of the advertisement effectiveness measuring device in correspondence with transmission source identification information (user ID); and a target reader information storing unit storing target reader information indicating a condition of a reader desirable as a target of the advertisement in correspondence with image identification information for identifying image information included in the advertisement. The detailed information providing unit may receive the transmission source identification information for identifying a transmission source along with the decoded information. In this case, the access totaling unit obtains the target reader information corresponding to the image identification information from the target reader information storing unit based on the image identification information included in the decoded information, obtains the user attribute information corresponding to the transmission source identification information from the user attribute storing unit based on the transmission source identification information, determines whether or not individual attributes of the transmission source satisfy the above described condition based on the target reader information and the user attribute information, and counts the number of users that satisfy the condition.

With such a configuration, individual information, etc. are managed in association with an advertisement, and whether or not there is an effect of the advertisement for readers as intended by the advertisement, namely, an effect of the advertisement can be measured in further detail.

Additionally, the advertisement effectiveness measuring device may further comprise an advertisement placement fee calculating unit calculating an advertisement placement fee for placing the advertisement in the printed matter based on the number of transmission sources to which the document is transmitted. With this configuration, the advertisement placement fee can be set based on a measurement result of an advertisement effect. Besides, the advertisement placement fee calculating unit may calculate the advertisement placement fee for placing the advertisement in the printed matter based on the number of transmission sources having the individual attributes that satisfy the condition, or may calculate the advertisement placement fee based on both the number of transmission sources that receive the document, and the number of transmission sources having the individual attributes that satisfy the condition.

Furthermore, in the advertisement effectiveness measuring device, the decoded information may include image position information indicating a position in which an advertisement is placed in the printed matter, and the number of transmission sources to which the document is transmitted may be totaled based on the image position information for each position in which the advertisement is placed. One advertisement can be possibly placed in different positions in the same printed matter. By configuring the device as described above, for one advertisement, the number of transmission sources can be totaled for each position in which the advertisement is placed. As a result, the effectiveness of the advertisement can be measured for each position in which the advertisement is placed.

Still further, in the advertisement effectiveness measuring device, the decoded information may include printed matter identification information for identifying a printed matter in which the advertisement is placed, and the number of transmission sources to which the document is transmitted may be totaled for each printed matter in which the advertisement is placed based on the printed matter identification information. One advertisement can be possibly placed in different printed matters. However, by configuring the device as described above, for one advertisement, the number of transmission sources can be counted for each printed matter in which the advertisement is placed.

Next, the information obtaining device used by readers of a printed matter is described. The information obtaining device used by the readers comprises: an image information reading unit reading an image which is included in an advertisement printed in a printed matter into a temporary storage area; an electronic watermark information decoding unit obtaining decoded information by decoding information which is embedded in the read image by using an electronic watermark; and an information communicating unit receiving a document from a computer that provides the document identified by document position information based on the document position information that is included in the decoded information, and indicates a position of the document on a network.

In this configuration, the image information reading unit is made to read the image, which is placed in a printed matter, into the temporary storage area, and the electronic watermark information decoding unit is made to decode the electronic watermark embedded in the read image. The information communicating unit receives the document indicated by the document position information, which is included in the decoded information, from the computer that provides the document. In this way, a reader can easily obtain detailed information about his or her advertisement of interest by using a printed matter.

Also with an advertisement effectiveness measuring method including steps similar to those of the process performed by the advertisement effectiveness measuring device, operativeness and effects similar to those of the advertisement effectiveness measuring device can be obtained, so that the above described objects can be achieved. Additionally, also with an information obtaining method comprising steps similar to those of the process performed by the information obtaining device used by readers, operativeness and effects similar to those of the information obtaining device can be obtained, so that the above described objects can be achieved.

Furthermore, also with a computer program for causing a computer to execute the process steps performed in the advertisement effect measuring method, the above described objects can be achieved by storing the computer program in a memory comprised by a computer, and by causing the computer to read the computer program from the memory and to execute the computer program. Similarly, also with a computer program for causing a computer to execute the process steps performed in the information obtaining method, the above described objects can be achieved.

Still further, a computer is made to read and load each program from a computer-readable storage medium on which each computer program is recorded, and thereafter, the computer is made to execute the computer program in a similar manner as in the aforementioned cases, whereby the above described objects can be achieved.

### BRIEF DESCRIPTION OF THE DRAWINGS

FIG. 1 shows the configuration of an information providing system;

FIG. 2 explains information exchanges in the information providing system;

FIG. 3 exemplifies the data structure of a user attribute table;

FIG. 4 exemplifies the data structure of an advertisement information table;

FIG. 5 explains printed matter identification information and image space position information;

FIG. 6 exemplifies the data structure of a target reader table;

FIG. 7 exemplifies the data structure of an advertisement placement fee table;

FIG. 8 exemplifies the data structure of a total table;

FIG. 9 is a flowchart showing the process performed when an advertisement request is accepted;

FIG. 10 explains the totaling of accesses from users, and the use of a result of the totaling;

FIG. 11 is a flowchart showing the process performed when a user accesses an information providing device;

FIG. 12 is a flowchart showing the process for calculating an advertisement placement fee;

FIG. 13 shows the configuration of a computer; and

FIG. 14 explains the loading of a program into a computer.

### DESCRIPTION OF THE PREFERRED EMBODIMENTS

Hereinafter, a preferred embodiment according to the present invention is described with reference to the drawings. The same devices, etc. are denoted with the same reference numerals, and their descriptions are omitted.

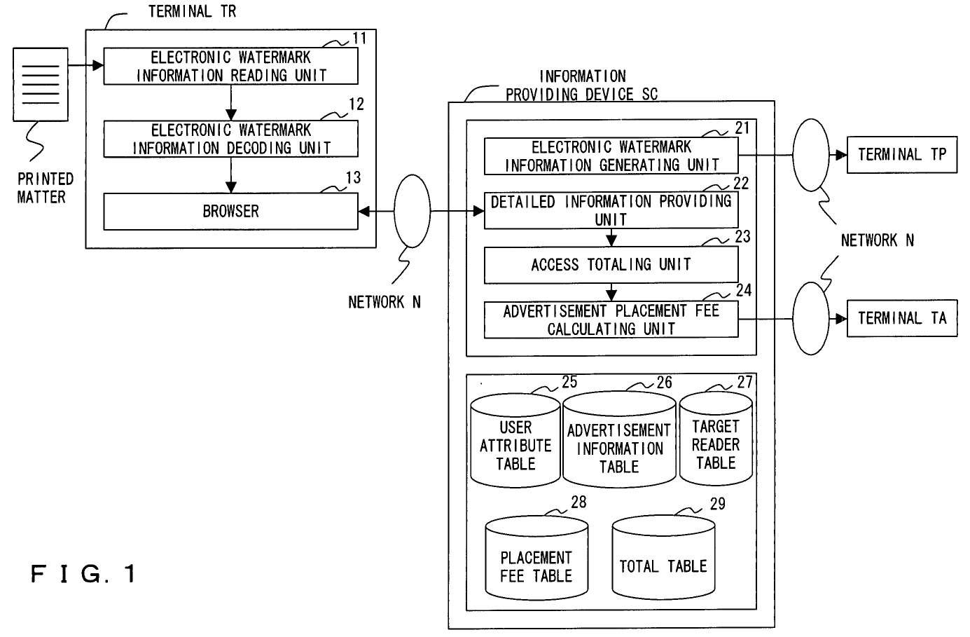

Firstly, the configuration of an information providing system is described with reference to FIG. 1. As shown in FIG. 1, the information providing system comprises terminals TR of readers R, a terminal TA of an advertiser A, a terminal TP of an issuer P, and an information providing device SC comprised by a service center C. The respective terminals TR, TA, and TP are connected to the information providing device SC via a network N. The network N may be one network, or a combination of a plurality of networks. As the network N, the Internet, a telephone line network, a WAN (Wide Area Network), a LAN (Local Area Network), etc. of a wireless line network, etc. are considered.

Each of the terminals TR comprises an electronic watermark information reading unit 11, an electronic watermark information decoding unit 12, and a browser 13. The electronic watermark information reading unit 11 is an inputting device for reading image information, which is printed in a printed matter in which an electronic watermark is embedded, into a temporary storage area within the terminal TR. Examples of the electronic watermark information reading unit 11 include a scanner, a digital camera, etc. The electronic watermark information decoding unit 12 comprises a function for decoding an electronic watermark generated by an electronic watermark information generating unit 21, and obtains access information by decoding an electronic watermark embedded in image information when the image information is read into the temporary storage area. Here, the access information includes document location information indicating a location of a document on a network, which is provided by the information providing device SC, image identification information for identifying a read image, and the like. The document includes detailed information about an advertisement. The electronic watermark information decoding unit 12 starts up the browser 13 when an electronic watermark is decoded. The browser 13 accesses the information providing device SC based on the document position information included in the access information, and receives the document. As a terminal TR, for example, a desktop computer, a cellular phone, a PDA (Personal Digital Assistance), a laptop computer, etc. are considered.

The advertiser A transmits to the information providing device SC printed matter identification information for identifying a printed matter in which an advertisement is desired to be placed, advertisement information including image space position information indicating a position of the advertisement in the printed matter, etc., and image information in which an electronic watermark is to be embedded by using the terminal TA. After the advertisement is placed, the advertiser A receives from the information providing device SC a result of totaling of accesses from the readers R who obtain detailed information about the advertisement, attributes such as their genders, ages, etc., and a notification of an advertisement placement fee according to the effect of the advertisement.

The issuer P obtains from the information providing device SC the image information (hereinafter referred to as electronic watermark information) in which the electronic watermark is embedded, and the advertisement information by using the terminal TP. The issuer P places the advertisement in a printed matter based on the electronic watermark information and the advertisement information. The printed matter is passed to the readers R via a sales store S. The readers R can use the printed matter as means for obtaining detailed information about the advertisement, whereas the information providing device SC can use the printed matter as means for measuring an effect of the advertisement.

The information providing device SC functions as a server of the respective terminals TR, TA, and TP. The information providing device SC comprises an electronic watermark information generating unit 21, a detailed information providing unit 22, an access totaling unit 23, an advertisement placement fee calculating unit 24, a user attribute table 25, an advertisement information table 26, a target reader table 27, a placement fee table 28, and a total table 29. The information providing device SC further comprises a table, not shown, for storing e-mail addresses of the advertiser A and the issuer P in order to transmit information to the advertiser A and the issuer P (since this table is obvious, its description is omitted).

The electronic watermark information generating unit 21 generates electronic watermark information by embedding an electronic mark in image information obtained from the terminal TA of the advertiser A, and transmits the generated electronic watermark information to the terminal TP of the issuer P. The detailed information providing unit 22 transmits a document (document including detailed information about the advertisement), which is indicated by document position information included in the access information, to a reader R who makes an access via the network N. When transmitting the detailed information, the detailed information providing unit 22 converts the detailed information into a format that suits the type of the terminal TR of the reader R. Furthermore, the access totaling unit 23 registers to the total table 29 the access information received from readers R, the user IDs of the readers R, an access count for each printed matter, etc.

The access totaling unit 23 totals an access history from the terminals TR of the readers R for each advertisement based on the image identification information, and transmits a result of totaling to the advertiser A. In addition, the access totaling unit 23 may also transmit at least part of the user attribute information of the readers R who receive the detailed information about the advertisement, when transmitting the result of totaling. The advertisement placement fee calculating unit 24 measures the effectiveness of an advertisement for each advertisement based on the information stored in the user attribute table 25, the total table 29, and the target reader table 27, calculates an advertisement placement fee based on a result of the measurement and the placement fee table 28, and transmits the advertisement placement fee to the advertiser A.

The user attribute table 25 stores the user attribute information about the readers R registered as users of the service center C. The advertisement information table 26 stores advertisement information about an advertisement placed in a printed matter. The target reader table 27 stores target reader information about readers targeted by each advertisement placed in a printed matter. The placement fee table 28 stores an advertisement placement fee to be charged to the advertiser A according to a result of the measurement of the effect of the advertisement for each advertisement. The total table 29 stores a result of totaling of accesses made from the readers R.

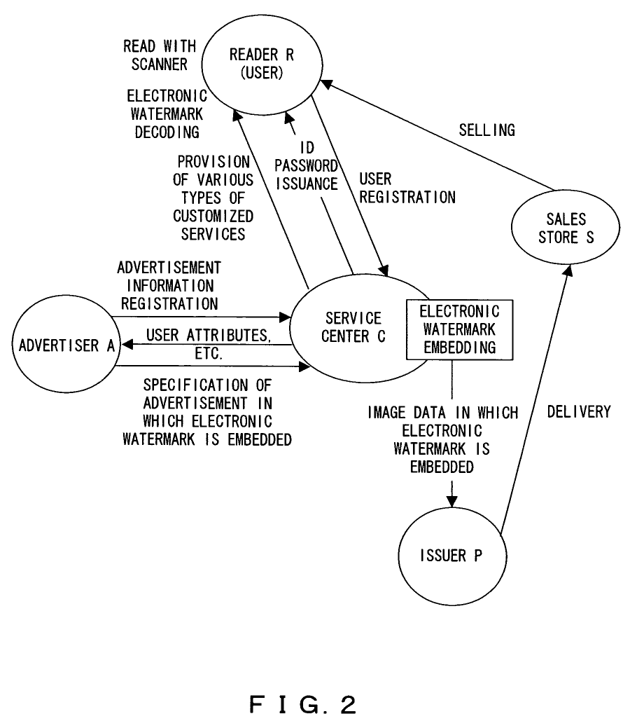

FIG. 2 shows the outline of exchanges of data and a printed matter in the information providing system according to the present invention. As shown in FIG. 2, readers R, an advertiser A, an issuer P, a sales store S, and a service center C are related to the information providing system.

The readers R are readers of a printed matter issued by the issuer P. The readers R are registered as users of the service center C, and have a user ID and a password for accessing a server SC (information providing device) comprised by the service center C. If a reader R desires to obtain detailed information about an advertisement placed in a printed matter, he or she inputs image information included in the advertisement to his or her terminal by using a reading device such as a scanner, etc. The terminal decodes an electronic watermark embedded in the image information. The electronic watermark includes information required for accessing the service center C, and information for identifying the advertisement. The reader R accesses the service center C from the terminal by using the decoded information, the user ID, and the password, so that he or she obtains from the service center C a document including the detailed information about the advertisement.

The advertiser A requests the service center C to place an advertisement in a printed matter issued by the issuer P by transmitting advertisement information, which is information desired to be advertised, to the service center C. At that time, the advertiser A specifies an image, in which an electronic watermark is desired to be embedded, for the service center C.

The service center C manages attribute information about the readers R registered as the users. Upon acceptance of the request to place the advertisement from the advertiser A, the service center C embeds the electronic watermark in the image information specified by the advertiser A, and transmits the image information to the issuer P. Additionally, the service center C creates a document on a network, which includes detailed information about the advertisement, and transmits the document to the terminal TR of a reader R who makes an access. Furthermore, the service center C collects a connection history of the readers R who receive the document, and provides to the advertiser A the user attribute information of the readers R who obtain the detailed information about the advertisement, based on the connection history.

The issuer P issues a printed matter, in which the advertisement information is placed, by using the image information in which the electronic watermark is embedded, and delivers the printed matter to the sales store S. Examples of the issuer P include a publisher of a magazine, a book, etc., a newspaper publisher, and the like. The sales store S sells the printed matter issued by the issuer P to the readers R.

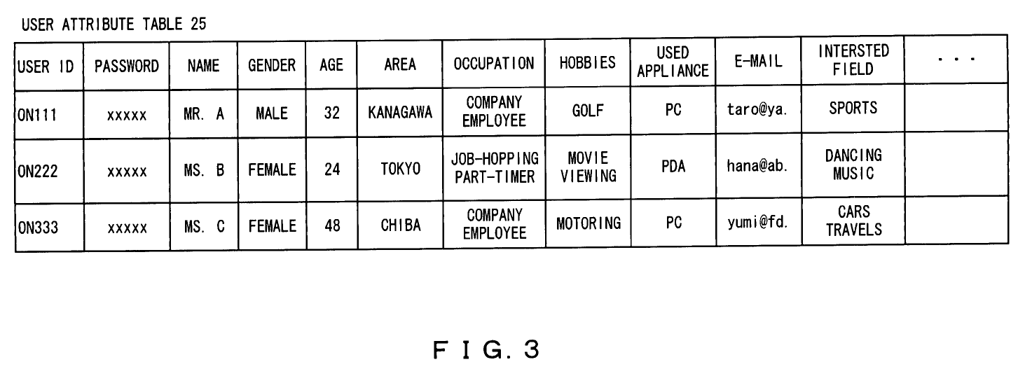

Data structures of the respective tables are described with reference to FIGS. 3 to 8. Firstly, the data structure of the user attribute table 25 is described with reference to FIG. 3. The user attribute table 25 stores user attribute information about readers R registered as users of the information providing device SC. As shown in FIG. 3, the user attribute information includes, as items, individual information of the users, such as a user ID for identifying a user, a password for accessing the information providing device SC, a name, gender, age, residence area, occupation, and hobbies of the user, the type of a terminal TR of the user, e-mail address, interested fields, etc. The user attribute information is registered to the user attribute table 25 by the information providing device SC based on information transmitted from a reader R to the information providing device SC, when the reader R is registered as a user of the information providing device SC.

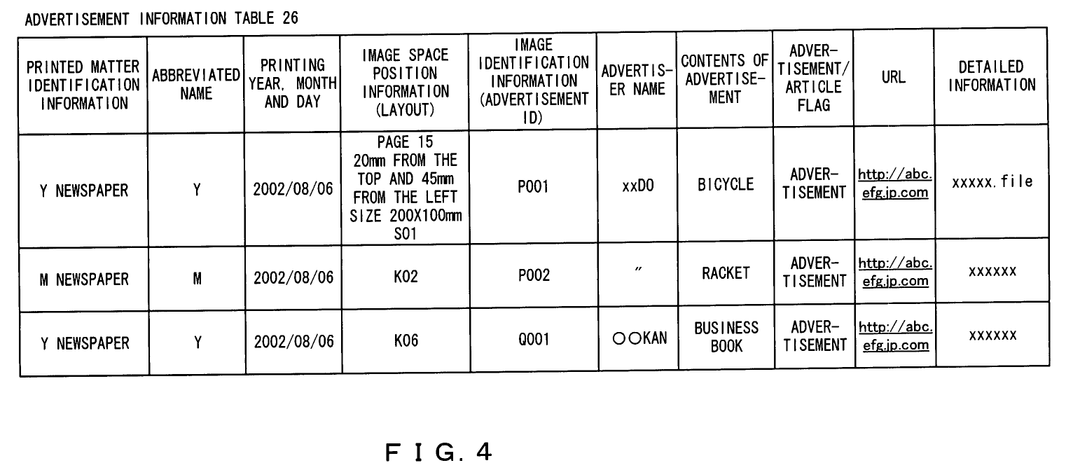

Next, the data structure of the advertisement information table 26 is described with reference to FIG. 4. The advertisement information table 26 stores advertisement information about an advertisement to be placed in a printed matter. As shown in FIG. 4, the advertisement information includes, as items, printed matter identification information for identifying a printed matter in which an advertisement is to be placed, an abbreviated name of the printed matter, year, month and day of printing, image space position information indicating a position in which an image is placed in the printed matter, image information desired to be placed, image identification information for identifying image information, an advertiser name, a field to which contents of the advertisement belongs, document position information indicating a position of a document on a network, and detailed information about the advertisement. The image identification information also serves as image identification information for identifying an advertisement. Information indicating a position in which an image is placed in a printed matter is named as image space position information. However, this is not intended to limit a medium, in which an advertisement is printed, to paper. Information except for document position information within advertisement information are obtained by the information providing device SC from the advertiser A when an advertisement request is accepted, and registered to the advertisement information table 26. The document location information is added to the advertisement information by the information providing device SC when a document on a network, which includes detailed information, is created.

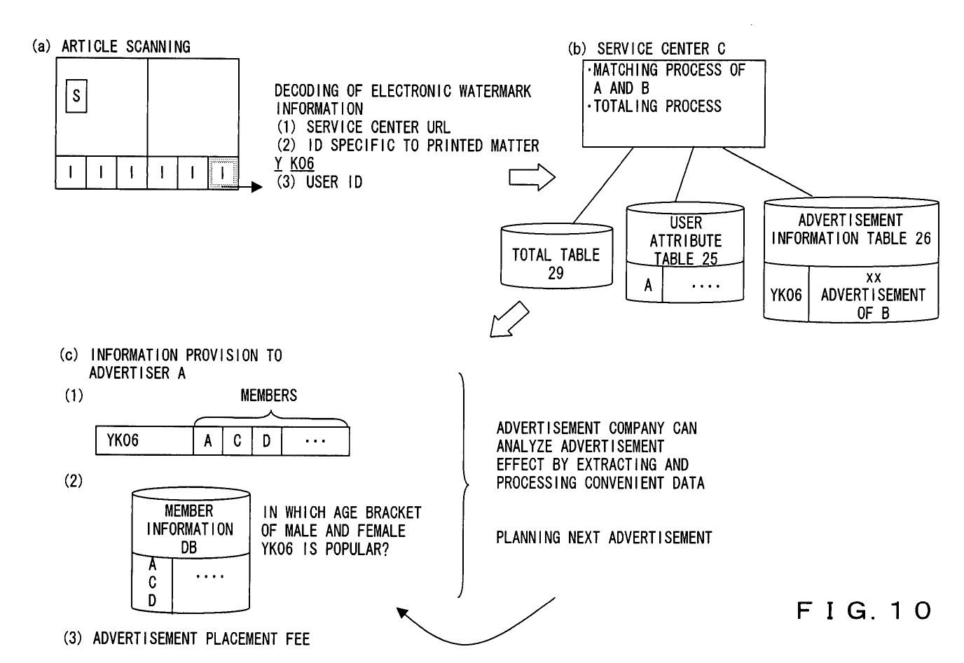

Examples of the document location information include a URI (Uniform Resource Indicator), a URL (Uniform Resource Locator), an IP address, etc. Although the document location information is indicated as URLs in FIGS. 4 and 10, these are merely examples, and are not intended to limit the document position information to URLs. The advertisement information is registered to the advertisement information table 26 by the information providing device SC upon receipt of a request to place an advertisement from the advertiser A.

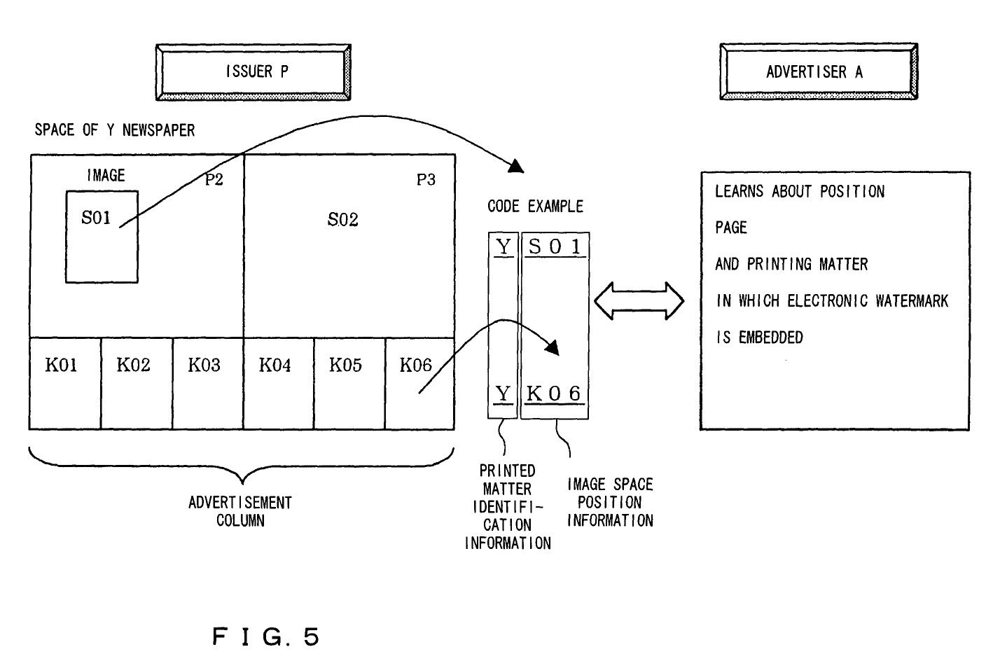

FIG. 5 explains information indicated by a combination of printed matter identification information and image space position information. FIG. 5 assumes the case where an advertisement is placed in “Y Newspaper”, which is a printed matter. As shown in FIG. 5, the space of each page of the “Y Newspaper” is partitioned into several portions, to each of which image space position information is assigned. In FIG. 5, each page of the “Y Newspaper” is partitioned into a portion (upper portion) that becomes the upper part when being read by a reader, and a portion (lower portion) that becomes the lower part, and the lower portion is further partitioned into three. Namely, each page is partitioned into 4 portions in total. Image space position information “S01” is assigned to the upper portion of a page 2, and “K01”, “K02”, and “K03” are assigned to the lower portion, which is partitioned into three, from the left when viewed from a reader. Similarly, “S02”, “K04”, “K05”, and “K06” are assigned to respective portions of a page 3.

The advertiser A can specify a position, a page, and a printed matter, where an image in which an electronic watermark is embedded is to be placed, by using printed matter identification information and image space position information, when requesting the issuer P to place an advertisement or an article in a printed matter. For example, if the printed matter identification information of the Y Newspaper is “Y”, the advertiser A can specify that an image is placed in an “upper portion of a page 2” of the “Y Newspaper” by combining the printed matter identification information “Y” and the image space position information “S01”. Or, the advertiser A can specify that the image is placed in the “right end portion on the lower part of page 3” of the “Y Newspaper” by combining the printed matter identification information “Y” and the image space position information “K06”.

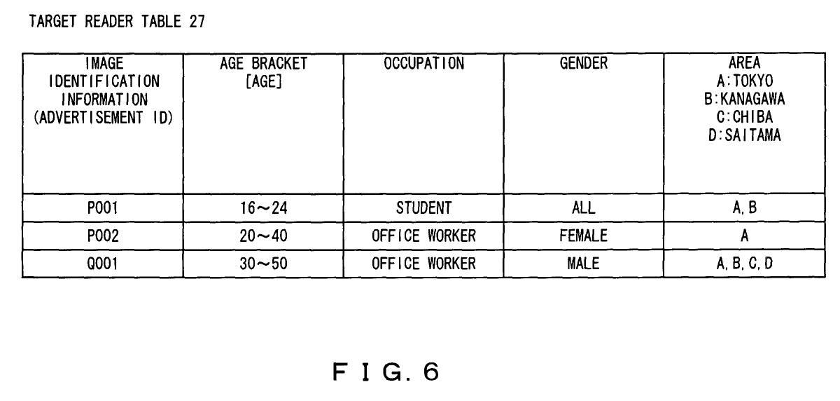

Next, the data structure of the target reader table 27 is described with reference to FIG. 6. The target reader table 27 stores target reader information about an advertisement for each advertisement. The target reader information indicates a condition of a reader desirable as a target of an advertisement. As shown in FIG. 6, the target reader information includes, as items, image identification information, and an age bracket, occupation, gender, and residence area of a target reader. The target reader information is received from the advertiser A along with advertisement information, and registered to the target reader table 27 by the information providing device SC.

For example, in FIG. 6, the details of a reader desirable as a target of an advertisement whose image identification information is “P001” indicate that an age bracket is “16 to 24”, an occupation is a “student”, a gender is “male or female”, and a residence area is “Tokyo or Kanagawa”.

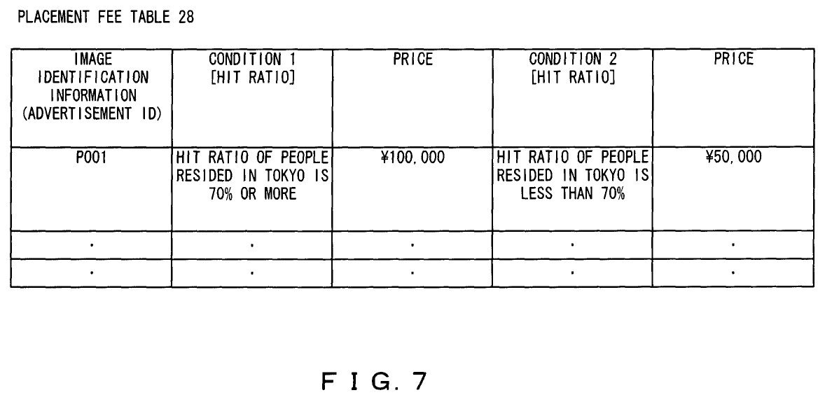

Next, the data structure of the placement fee table 28 is described with reference to FIG. 7. The placement fee table 28 stores placement fee information that indicates an advertisement placement fee of an advertisement according to the effectiveness of the advertisement for each advertisement. The placement fee information includes image identification information for identifying an advertisement (image) with which its placement fee information is associated, a placement fee, and a condition for setting the placement fee. The placement fee information is received from the advertiser A or the issuer P based on an agreement between the advertiser A and the issuer P, in principle, before the advertisement is placed in a printed matter, and registered to the placement fee table 28 by the information providing device SC.

For example, in FIG. 7, it is indicated that an advertisement placement fee of an advertisement whose image identification information is “P001” is “100,000” yen if a condition that “the ratio of people who reside in Tokyo and make an access is 70% or more” is satisfied, or the advertisement placement fee is “50,000” yen if a condition that “the ratio of people who reside in Tokyo and make an access is less than 70%” is satisfied.

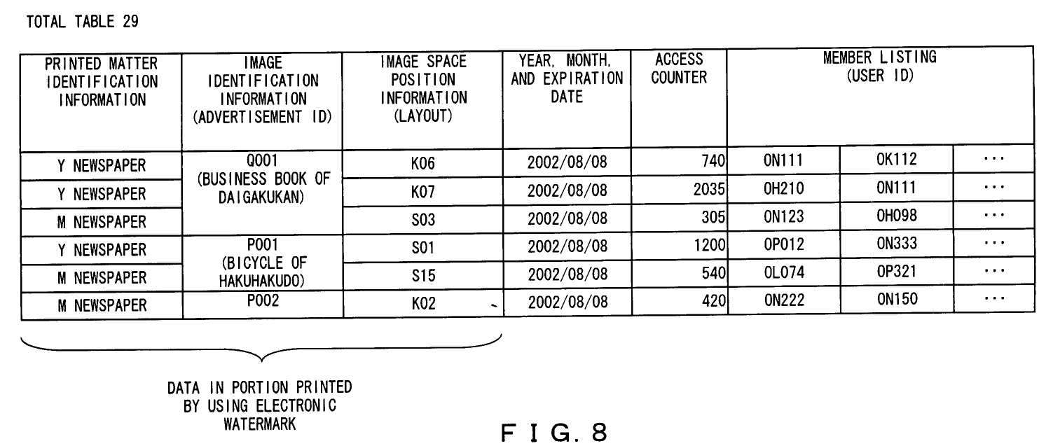

Lastly, the data structure of the total table 29 is described with reference to FIG. 8. The total table stores access total information about readers R who obtain detailed information about an advertisement for each advertisement. If one advertisement is placed in a plurality of printed matters, total information about that advertisement is totaled for each of the printed matters. Or, if one advertisement is placed in a plurality of positions of the same printed matter, total information about that advertisement is totaled for each of the positions in which the advertisement is placed in the printed matter.

The access total information includes, as items, printed matter identification information of a printed matter in which an advertisement associated with totaling is placed, image identification information, image space position information, year, month and day of an expiration date, an access count of readers R who obtain detailed information about the advertisement associated with totaling, and user IDs of readers who make an access. The access total information is registered to the total table 29 by the time a printed matter is issued. At the beginning of registration, the access count and the user ID items are empty. The access count and the user ID are registered/updated by the access totaling unit 23 of the information providing device SC based on an access record of the readers R.

For example, in FIG. 8, an advertisement whose image identification information is “Q001” is placed in three positions in total, such as positions “K06” and “K07” in a page space of the “Y Newspaper”, and a position “S03” in a page space of “M Newspaper”. Accordingly, the total information about that advertisement is totaled by being divided into the three placement positions. Access counts from readers R who view the advertisement placed in the respective positions are proved to be “740”, “2035”, and “305” respectively.

Next, processes performed by the information providing device SC are described.

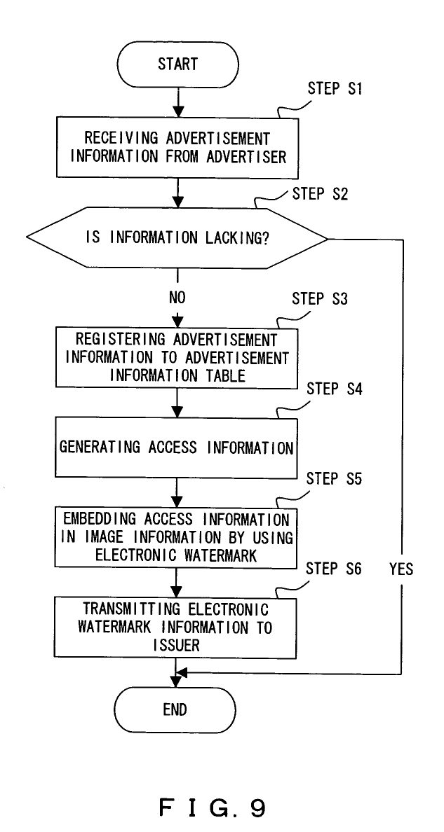

First of all, a process performed when the information providing device SC accepts an advertisement request from the advertiser A is described with reference to FIG. 9. Firstly, the information providing device SC receives advertisement information from the advertiser A (S1).

The information providing device SC verifies whether or not the advertisement information is lacking or has an abnormality (S2). If the information is lacking or has an abnormality (“Yes” in S2), the information providing device SC notifies the advertiser A that the advertisement information is lacking or has an abnormality, and terminates the process. If the advertisement information is not lacking or an abnormality (“No” in S2), the information providing device SC registers the advertisement information to the advertisement information table 26, and accepts the advertisement request (S3). Then, the electronic watermark information generating unit 21 of the information providing device SC generates access information based on printed matter identification information, image identification information, image space position information, and document position information, which are included in the advertisement information (S4), and generates electronic watermark information by embedding the generated access information in image information by using an electronic watermark (S5). Then, the electronic watermark information generating unit 21 transmits the generated electronic watermark information, year, month and day of printing (issuance scheduled date), the image space position information, the image identification information, the name of the advertiser, contents of the advertisement, etc. to the issuer P that issues the printed matter based on the printed matter identification information included in the advertisement information (S6), and terminates the process. The issuer P issues the printed matter where the image information in which the electronic watermark is embedded is printed based on this information.

Thereafter, the detailed information providing unit 22 creates a document on a network, which includes detailed information, and adds document position information indicating a location of the document on the network to the advertisement information about the advertisement within the advertisement information table 26.

The electronic watermark information generated by the electronic watermark information generating unit 21 is described below. The electronic watermark information generating unit 21 generates access information including printed matter identification information, image identification information, and image space position information of the advertisement information table 26, and generates electronic watermark information by embedding the access information in image information received from the advertiser A by using an electronic watermark.

It is desirable that an electronic watermark embedded in image information satisfies the following conditions:

(1) An electronic watermark is an invisible watermark so as not to degrade the quality of an image placed in a printed matter.

(2) Even if image information is read from a printed matter with a scanner, etc. after the image information is printed in a page space, etc., information embedded in the image information can be decoded.

A method embedding information by using an invisible watermark is exemplified below. Other methods exist as a method embedding information by using an invisible watermark. Any method may be adopted as far as the method satisfies the above described conditions. Details of the method embedding invisible information in an image printed in a page space, etc. is recited in documents such as Japanese Patent Publication No. 2001-230923, etc.

(1) a Method Changing a Start Position of a Printing Line

The start position of a printing line is changed according to information desired to be embedded.

(2) a Method Changing an Interval between Printing Lines

An interval between printing lines is changed according to information desired to be embedded.

(3) a Method Changing a Dot Interval

A dot size in the direction of a printing line is changed according to information desired to be embedded.

Next, the outline of a process, which is performed by the information providing device SC when a reader who obtains a printed matter issued as described above acquires detailed information about an advertisement from the information providing device SC, is described with reference to FIG. 10.

Firstly, the electronic watermark reading unit 11 within a terminal TR of a reader R reads image information which is included in an advertisement placed in a printed matter into the terminal TR. The electronic watermark information decoding unit 12 obtains access information by decoding an electronic watermark embedded in the read image. When the access information is obtained, the browser 13 accesses the information providing device SC based on document location information included in the access information, and transmits a user ID, printed matter identification information, image identification information, and image space position information to the information providing device SC of the service center SC. As a reply, the terminal TR receives a document including detailed information about the advertisement from the information providing device SC.

Then, the information providing device SC, the detailed information providing unit 22 as shown in FIG. 1, transmits the detailed information about the advertisement to the reader R, when the reader R makes the access. Furthermore, the information providing device SC obtains user attribute information of the reader R, and target reader information about the advertisement from the user attribute table 25 and the advertisement information table 26, and determines whether or not the reader R satisfies a condition of a reader desirable as a target of the advertisement. Furthermore, the information providing device SC collects an access log of accesses from readers R, and totals accesses.

Lastly, the information providing device SC transmits to the advertiser A total information indicating a breakdown of the readers R who obtain the detailed information about the advertisement, and information indicating the user attribute information of the readers R, and notifies the advertiser A of an advertisement placement fee based on the effectiveness of the advertisement. The advertiser A analyzes the effectiveness of the advertisement in further detail based on the total information and the user attribute information, and can utilize a result of the analysis when planning a future advertisement.

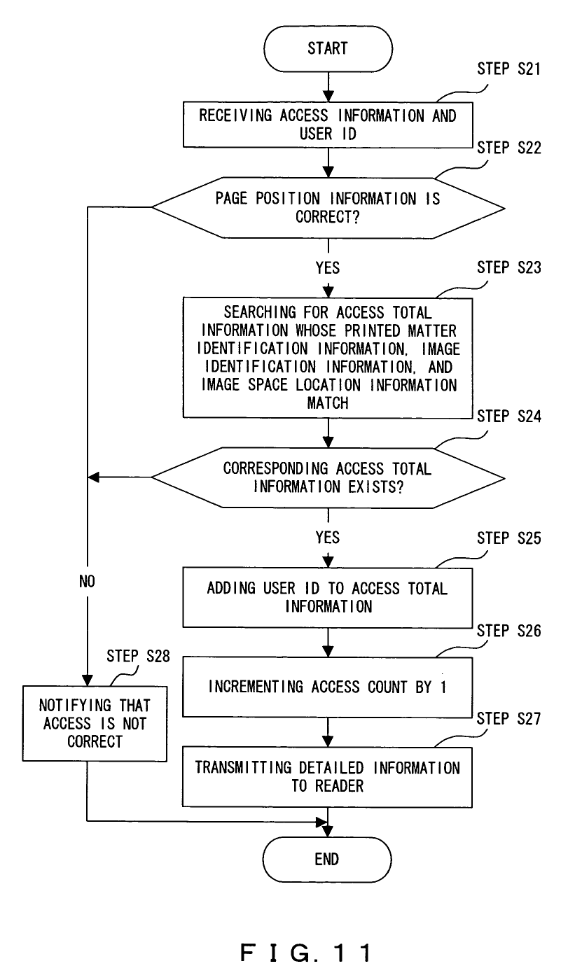

Next, the process, which is performed by the information providing device SC when a reader accesses the information providing device SC, is described in further detail with reference to FIG. 11. The following description is provided by assuming that a cumulative number of accesses (the number of receivers) is totaled.

As shown in FIG. 11, upon receipt of a user ID and access information from a terminal TR (S21), the detailed information providing unit 22 determines whether or not document position information included in the access information is correct (S22). If the document position information is correct (“Yes” in S22), the process proceeds to S23. Otherwise (“No” in S22), the process proceeds to S28.

In S23, the detailed information providing unit 22 searches the total table 29 for access total information, which includes as items printed matter identification information, image identification information, and image space position information, which match those included in the access information. If corresponding access total information is registered to the total table 29 as a result of the search (“Yes” in S24), the process proceeds to S25. In this case, it is verified that a printed matter, where an image in which the access information is embedded is placed, exists, and the reader R makes the access by viewing that printed matter. Otherwise (“No” in S24), the detailed information providing unit 22 determines that the access is not correct, notifies the reader R that the access is not correct (not shown), and terminates the process.

In S25, the detailed information providing unit 22 adds the user ID received from the reader R who makes the access to the obtained access total information. Then, the detailed information providing unit 22 increments the value of the access count, which is included in the access total information, by 1 (S26). Furthermore, the detailed information providing unit 22 outputs a document, which is indicated by the received document position information and includes detailed information about the advertisement, to the terminal TR of the reader R(S27), and terminates the process.

In S28, the detailed information providing unit 22 determines that the access is not correct, notifies the reader R that the access is not correct, and terminates the process.

In this way, the detailed information providing unit 22 provides detailed information about an advertisement viewed by readers R to the readers R who make an access, and totals the accesses from the readers R according to the advertisement, a printed matter in which the advertisement is placed, and a position in a page space, in which the advertisement is placed.

A result of the totaling may be transmitted to the advertiser A of the advertisement at a predetermined time everyday. Or, access total information about the advertisement may be quickly transmitted to the advertiser A after an expiration date (stored in the total table 29) of a time period (totaling period) during which accesses from readers R are totaled comes.

Furthermore, the above description is provided by assuming that the total number of accesses (the total number of users) is counted. However, the number of accesses (the number of users) from which a repetition is excluded, namely, a plural number of accesses made by one reader may be counted as one. In this case, it is determined whether or not a user ID is already included in the access total information in the total table 29 prior to S25. If the user ID is already included in the access total information, the user ID is not added to the access total information in S25, and the access count is not incremented by 1 in S26.

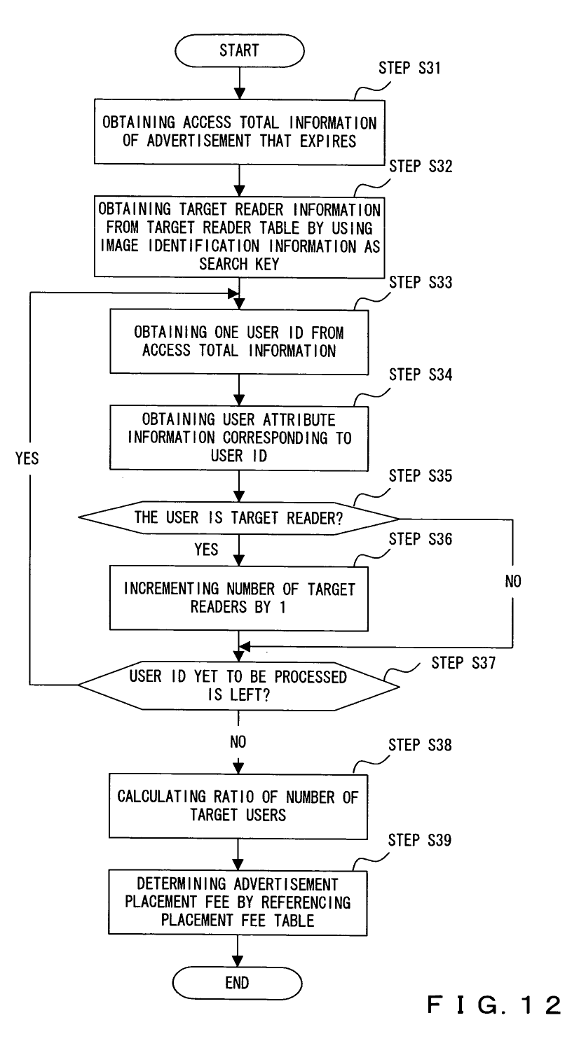

Next, a process in which the information providing device SC calculates an advertisement placement fee is described with reference to FIG. 12. A time period (totaling period) during which accesses from readers R are totaled is predetermined for each advertisement so as to measure the effectiveness of an advertisement placed in a printed matter. This process is performed for each advertisement whose totaling time period expires. The following description is provided by assuming that an advertisement placement fee is calculated based on a ratio of readers who satisfy a condition indicated by target reader information among readers who obtain detailed information about the advertisement. However, this is merely an example. It is possible to use information other than the ratio so as to calculate an advertisement placement fee, as a matter of course. For example, an advertisement placement fee may be also calculated based on the total number of readers R who obtain detailed information about an advertisement, and satisfy a condition indicated by target reader information.

Firstly, the advertisement placement fee calculating unit 24 within the information providing device SC obtains access total information of an advertisement, whose totaling time period expires, from the total table 29 based on year, month and day of the expiration date within the total table 29 (S31).

The advertisement placement fee calculating unit 24 obtains target reader information from the target reader table 27 by using image identification information included in the obtained access total information as a search key (S32). Furthermore, the advertisement placement fee calculating unit 24 extracts one user ID from the access total information (S33), and obtains user attribute information corresponding to the user ID from the user attribute table 25 (S34). The advertisement placement fee calculating unit 24 determines whether or not the reader R corresponding to the user ID satisfies a condition indicated by the target reader information based on the user attribute information and the target reader information (S35) . If the reader R satisfies the condition indicated by the target reader information (“Yes” in S35), the reader R is a reader targeted by the advertisement. Therefore, the number of target readers, which indicates the number of target readers who obtain the detailed information about the advertisement, is incremented by 1 (S36), and the process proceeds to S37. Otherwise, the process proceeds to S37 without performing S36.

In S37, the advertisement placement fee calculating unit 24 determines whether or not a user ID for which the operations in S33 to S36 are not yet performed is left among user IDs included in the access total information which is obtained in S31 (S37). If a user ID for which the operations are not yet performed is left, the process returns to S33. If the operations have been performed for all of the user IDs (“No” in S37), the process proceeds to S38.

In S38, the advertisement placement fee calculating unit 24 calculates the ratio of readers R who satisfy the condition of a reader targeted by the advertisement among the readers R who make an access based on the number of target readers counted and the access count included in the access total information. Then, the advertisement placement fee calculating unit 24 obtains advertisement placement fee information of the advertisement from the placement fee table 28 by using image identification information as a search key, calculates an advertisement placement fee of the advertisement according to an effect of the advertisement based on the placement fee information and the ratio calculated in S38 (S39), and notifies the advertiser A who requests to place the advertisement of the calculated advertisement placement fee.

If the reader R corresponding to the user ID is determined not to be a target reader in S35, the number of readers who are not target readers (the number of non-target readers) may be incremented by 1 before the process jumps to S37. In this way, the status of interest in the advertisement from the readers R, which is not expected by the advertiser A, can be totaled, and in consequence, previously unknown target readers can be discovered. The name of the advertiser A is included in the advertisement information, and the advertisement placement fee calculating unit 24 can obtain the name of the advertiser A by obtaining the advertisement information about the advertisement from the advertisement information table 26 by using the image identification information as a search key.

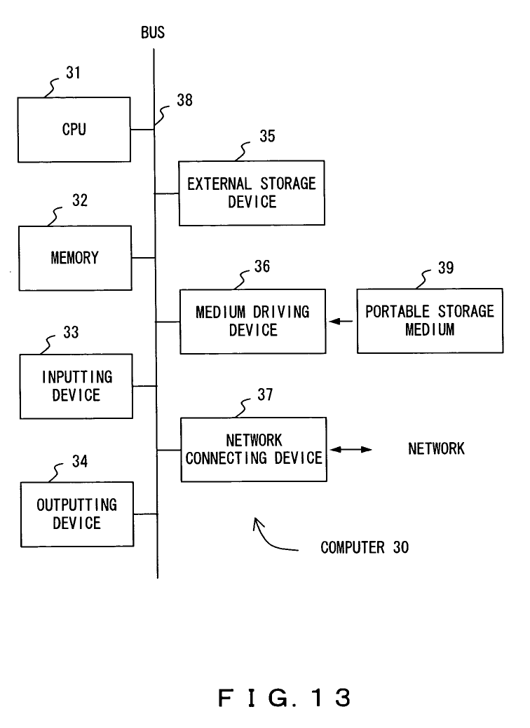

The above described information providing device SC and the terminals TR of the readers R can be configured by using a computer. The configuration of the computer is described below with reference to FIG. 13.

As shown in FIG. 13, a computer 30 comprises a CPU 31, a memory 32, an inputting device 33, an outputting device 34, an external storage device 35, a medium driving device 36, and a network connecting device 37, which are interconnected by a bus 38.

The memory 32 includes, for example, a ROM (Read-Only Memory), a RAM (Random Access Memory), etc., and stores a program and data, which are used for processes. A record or data read from the respective tables 25 to 29 are temporarily stored in the memory 32. If the information providing device SC is configured by using a computer, the electronic watermark information generating unit 21, the detailed information providing unit 22, the access totaling unit 23, and the advertisement placement fee calculating unit 24 are stored as a program in a particular program code segment in the memory 32 of the computer 30. At the same time, if a terminal TR is configured by using a computer, the electronic watermark decoding unit 12 and the browser 13 are stored as a program in a particular program code segment in the memory 32 of the computer 30 in a similar manner as in the above described case.

The CPU 31 performs necessary processes by executing the above described program with the memory 32.

The inputting device 33 is, for example, a keyboard, a pointing device, a touch panel, etc., and is used to input an instruction or information from a user. The outputting device 34 is, for example, a display, a printer, etc., and is used to output an inquiry of the computer to a user, a process result, etc. Or, if a terminal TR is configured by using a computer, for example, a scanner, a digital camera, etc. are cited as the inputting device 33 for implementing the electronic watermark information reading unit 11.

The external storage device 35 is, for example, a magnetic disk device, an optical disk device, a magneto-optical disk device, etc. The external storage device 35 implements the user attribute table 25, the advertisement information table 26, the target reader table 27, the placement fee table 28, and the total table 29. Furthermore, the above described program may be stored in the external storage device 35 of the computer 30, loaded into the memory 32 and used depending on need.

The medium driving device 36 drives a portable storage medium 39, and accesses its stored contents. As the portable storage medium 39, an arbitrary computer-readable storage medium such as a memory card, a memory stick, a flexible disk, a CD-ROM (Compact Disc Read-Only Memory), an optical disk, a magneto-optical disk, a DVD (Digital Versatile Disk), etc. is used. The above described program may be also stored onto the portable storage medium 39, loaded into the memory 32 of the computer 30 and used depending on need.

The network connecting device 37 communicates with external devices such as the respective terminals TR, TP, and TA via an arbitrary network (line) such as a LAN, a WAN, etc., and performs data conversion accompanying a communication. Additionally, the above described program may be also received from an external device, loaded into the memory 32 of the computer 30 and used depending on need.

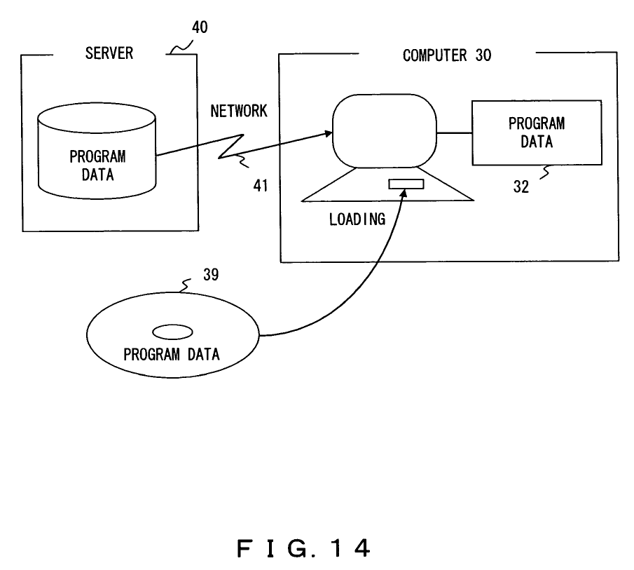

FIG. 14 explains the loading of a program or data into the computer shown in FIG. 13.

To make the computer execute the functions corresponding to the information providing device SC or a terminal TR, which are described in the aforementioned preferred embodiment, also a method using the storage medium 39 exists other than the method inputting the program to the computer via the inputting device 33. To implement this, the above described program is prestored onto the computer-readable storage medium 39. Then, as shown in FIG. 14, it may be configured so that the computer is made to read the program from the storage medium 39, the memory 32 or the external storage device 35 of the computer is made to temporarily store the program, and the CPU 31 comprised by the computer is made to read and execute the stored program.

Or, the program may be downloaded from a DB possessed by a program (data) provider 40 via a communications line (network) 41. In this case, for example, a computer on a transmitting side, which is possessed by the program (data) provider 40, converts program data, which represents the program, into a program data signal, obtains a transmission signal by modulating the converted program data signal with a modem, and outputs the obtained transmission signal to the communications line 41 (transmission medium). A computer that receives the program obtains a program data signal by demodulating the received transmission signal with a modem, and obtains program data by converting the obtained program data signal. If the communications line 41 (transmission medium) that connects between the computers on the transmitting side and the computer on the receiving side is a digital line, the program data signal may be also communicated. Furthermore, a computer of a telephone office, etc. may exist between the computer which transmits the program and the computer which downloads the program.

Up to this point, the preferred embodiment according the present invention is described. The present invention is not limited to the above described preferred embodiment and modifications. Other various changes can be made.

For example, the above provided description refers to the case where an advertisement is placed in a printed matter. Additional information may be added by using an electronic watermark to image information included in an article placed in a printed matter. In this case, readers R obtain detailed information about the article, and an issuer P can measure responses of the readers to the article as the number of readers who obtain the detailed information. Besides, in this case, the information providing device SC may further comprise an information selection condition table in order to change detailed information to be provided to a reader according to the user attribute information of the reader R. The information selection condition table sets detailed information to be provided to a reader R according to a condition satisfied by user attribute information. Then, the information providing device SC provides the detailed information suitable for the reader R to the reader R based on the user attribute information of the reader.

More specifically, in the case of an article about professional baseball, setting to provide detailed information about the article from a viewpoint of a fan of a baseball team A may be made in the information selection condition table if information indicating that the reader is a fan of the baseball team A is included in the user attribute information. Otherwise, setting to provide detailed information about the article from a different viewpoint may be made. In this way, when detailed information is provided to a reader R, either of two types of detailed information set in the information selection condition table can be provided to the reader R based on the user attribute information of the reader R.

The above provided description explains that the information providing device SC is a device independent of both the issuer P and the advertiser A. The information providing device SC may be comprised by the issuer P. If an advertisement agency exists between the issuer P and the advertiser A, the advertisement agency may comprise the information providing device SC.

As described above in detail, according to the present invention, information is embedded by using an electronic watermark in image information which is included in an advertisement placed in a printed matter, whereby additional information can be added to the advertisement without sparing a page space in which the advertisement is placed.

Furthermore, according to the present invention, information embedded by using an electronic watermark in image information includes document location information indicating a location of a document on a network, which includes detailed information about an advertisement. The document is transmitted to transmission sources that transmit the document location information, which is obtained by decoding the electronic watermark embedded in the image information, and meanwhile, the number of the transmission sources is counted, whereby the effectiveness of the advertisement can be measured.

What is claimed is:

1. An advertisement effectiveness measuring method with which a computer measures the effectiveness of an advertisement, comprising:
receiving decoded information obtained by decoding an electronic watermark embedded in image information which is included in the advertisement printed in a printed matter;
counting a number of transmission sources of the decoded information; and
transmitting a document including detailed information about the advertisement to the transmission sources of the decoded information based on document location information indicating a location of the document on a network, which is included in the decoded information.

2. The advertisement effectiveness measuring method according to claim 1, further comprising:
receiving transmission source identification information for identifying a transmission source that transmits the decoded information;
obtaining target reader information corresponding to image identification information from a storing unit storing target reader information indicating a condition of a reader desirable as a target of the advertisement based on the image identification information for identifying the image information, which is included in the decoded information;
obtaining user attribute information corresponding to the transmission source identification information from a storing unit storing user attribute information indicating individual attributes of a user, based on the transmission source identification information;
determining whether or not individual attributes of a user corresponding to the transmission source identification information satisfy the condition based on the target reader information and the user attribute information; and
counting the number of transmission sources that satisfy the condition.

3. The advertisement effectiveness measuring method according to claim 1, further comprising
calculating an advertisement placement fee for placing the advertisement in the printed matter based on the number of transmission sources of the decoded information.

4. The advertisement effectiveness measuring method according to claim 2, further comprising
calculating an advertisement placement fee for placing the advertisement in the printed matter based on the number of transmission sources that satisfy the condition.

5. The advertisement effectiveness measuring method according to claim 1, wherein:
the decoded information includes image position information indicating a position in which the advertisement is placed in the printed matter; and
the number of transmission sources that obtain the detailed information about the advertisement is totaled for each position in which the advertisement is placed, based on the image position information.

6. The advertisement effectiveness measuring method according to claim 1, wherein:
the decoded information includes printed matter identification information for identifying a printed matter in which the advertisement is placed; and
the number of transmission sources that obtain the detailed information is totaled for each position in which the advertisement is placed, based on the printed matter identification information.

7. An advertisement effectiveness measuring device measuring the effectiveness of an advertisement, comprising:
a detailed information providing unit receiving decoded information obtained by decoding an electronic watermark embedded in image information which is included in the advertisement printed in a printed matter, and transmitting a document including detailed information about the advertisement to transmission sources of the decoded information based on document position information indicating a position of the document on a network, which is included in the decoded information; and
an access totaling unit counting a number of the transmission sources of the decoded information.

8. A computer program for causing a computer to perform a control for measuring the effectiveness of an advertisement, the control comprising:
receiving decoded information obtained by decoding an electronic watermark embedded in image information which is included in the advertisement printed in a printed matter;
counting a number of transmission sources of the decoded information; and
transmitting a document including detailed information about the advertisement to the transmission sources of the decoded information based on document location information indicating a location of the document on a network, which is included in the decoded information.

9. A computer-readable storage medium on which is recorded a program for causing a computer to perform a control for measuring an effect of an advertisement, the control comprising:
receiving decoded information obtained by decoding an electronic watermark embedded in image information which is included in the advertisement printed in a printed matter;
counting a number of transmission sources of the decoded information; and
transmitting a document including detailed information about the advertisement to the transmission sources of the decoded information based on document position information indicating a position of a document on a network, which is included in the decoded information.

10. An image creating method creating image information which is included in an advertisement placed in a printed matter, comprising:
obtaining printed matter identification information for identifying a printed matter in which the advertisement is to be placed, image position information for identifying a position in which the advertisement is placed, and the image information; and
embedding image identification information for identifying the image, the printed matter identification information, and the image position information in the image information by using an electronic watermark.

11. Image information which is included in an advertisement placed in a printed matter, wherein:
document position information indicating a position of a document on a network is embedded by using an electronic watermark;
the information, which is embedded by using the electronic watermark, is decoded by a computer when the image information is read by the computer;
the document position information is transmitted from the computer to a different computer that provides the document; and
the document is transmitted from the different computer to the computer.

12. An information obtaining method with which a computer obtains a document including information about an advertisement, comprising:
reading image information, which is included in an advertisement printed in a printed matter, into a temporary storage area;
obtaining decoded information by decoding information which is embedded in the read image by using an electronic watermark; and
receiving the document from a different computer that provides the document, based on document location information which is included in the decoded information, and indicates a location of the document on a network.
